(19) United States
(12) Patent Application Publication
(10) Pub. No.: US 2014/0008461 A1
(43) Pub. Date: Jan. 9, 2014

(54) FAN WITH ATOMIZATION NOZZLES

(71) Applicant: Yu-Min Cheng, Taichung City (TW)

(72) Inventor: Yun-Cheng Shiun, Taichung City (TW)

(73) Assignee: Yu-Min Cheng, Taichung City (TW)

(21) Appl. No.: 14/019,536

(22) Filed: Sep. 5, 2013

(30) Foreign Application Priority Data
Jun. 9, 2012 (TW) 101132454

(51) Int. Cl. B05B 7/00

(52) U.S. Cl. CPC B05B 7/0075
USPC 239/302

(57) ABSTRACT

A fan includes a pump unit which drives the motor and the shaft of the motor so as to rotate the blades to generate air flows. The pump unit pumps water from the reservoir and sends water to the nozzles of the nozzle unit via the inlet tube and the outlet tube. The water is atomized and spread out from the nozzles. The fan uses the pump unit to drive the motor and operate the fan blades, and the water is spread out from the nozzles via the inlet tube and the outlet tube. The fan has a simple structure and saves energy required.

### FIELD OF THE INVENTION

The present invention relates to a fan, and more particularly, to a fan with multiple atomization nozzles which spread atomized water particles to cool the air temperature.

### BACKGROUND OF THE INVENTION

The conventional fan 40 with atomization nozzles is disclosed in FIGS. 6 and 7, and generally comprises a motor and blades unit 41, a pump 42, an atomization nozzle unit 43 and a reservoir 44. The pump 42 is connected between the reservoir 44 and the atomization nozzle unit 43. The water sucked by the pump 42 is atomized and spread by the atomization nozzle unit 43. The atomized water particles are blown by the blades of the fan to cool the air temperature.

However, the conventional fan has a complicated structure which comprises the pump 42 connected between the reservoir 44 and the atomization nozzle unit 43, and the water sucked by the pump 42 is atomized and spread by the atomization nozzle unit 43. The water has to be processed by different devices to be spread into the air. Besides, the electric energy required for operating the conventional fan is high and this means a high expense for the energy is required.

The present invention intends to provide a fan with multiple atomization nozzles and which improves the shortcomings of the conventional fan.

### SUMMARY OF THE INVENTION

The present invention relates to a fan and comprises a pump unit having a motor, a frame, a clutch and a cable. The motor has a shaft. The frame has an inlet and an outlet. The inlet is connected with an inlet tube, and the outlet is connected with an outlet tube. A nozzle unit has a T-shaped one-way part which has an input end, an output end and a one-way end. An input tube is connected between the input end and the one-way end. Multiple nozzles are connected to the input tube. The input end of the T-shaped one-way part is connected with the outlet tube of the outlet of the frame. A reservoir has a space defined therein, and a connector is connected to the reservoir. The inlet tube of the inlet of the frame is connected to the connector.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the fan of the present invention;

FIG. 2 is a perspective view to show the pump unit of the fan of the present invention;

FIG. 3 is a perspective view to show the pump unit and the shaft of the fan of the present invention;

FIG. 4 is a side view of the pump unit and the shaft of the fan of the present invention;

FIG. 5 shows that the water is spread from the nozzles of the fan of the present invention;

FIG. 6 is a perspective view to show a conventional fan of the present invention, and

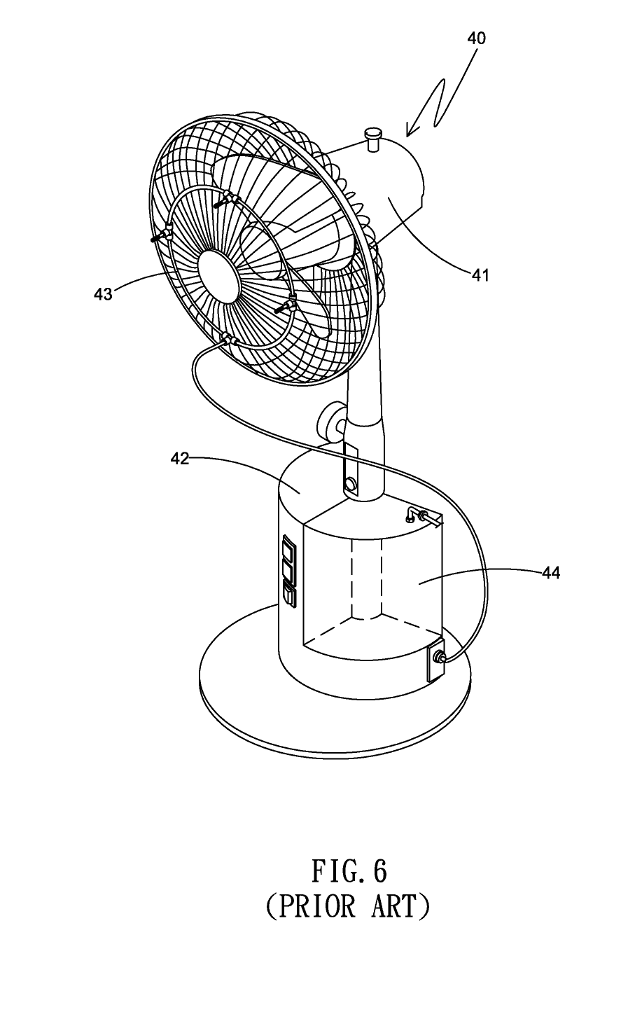

FIG. 7 is a perspective view to show another conventional fan of the present invention.

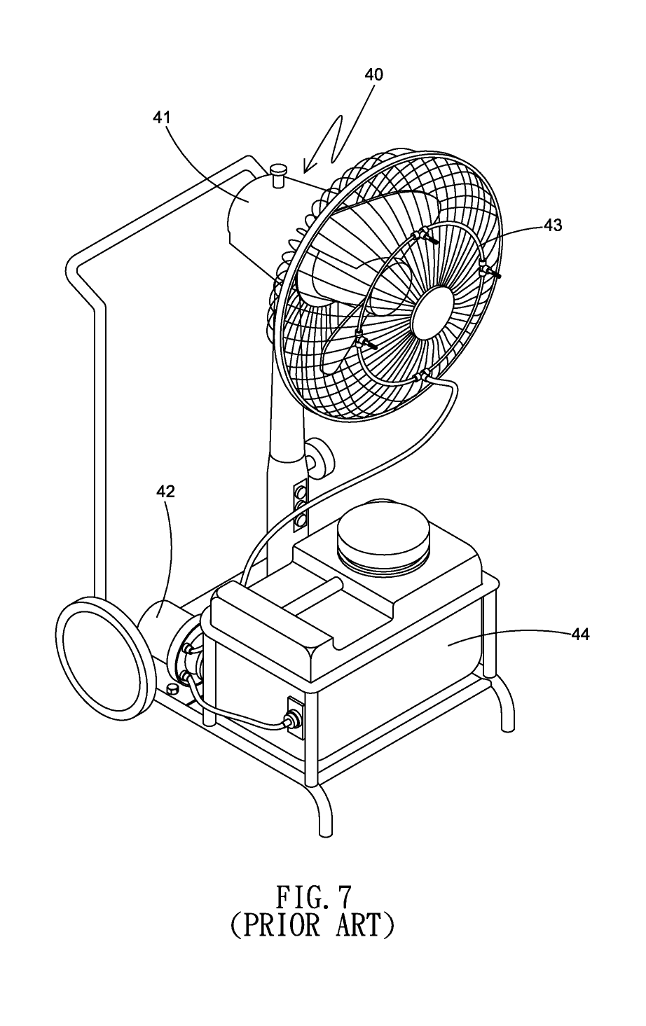

### DETAILED DESCRIPTION OF THE PREFERRED EMBODIMENT

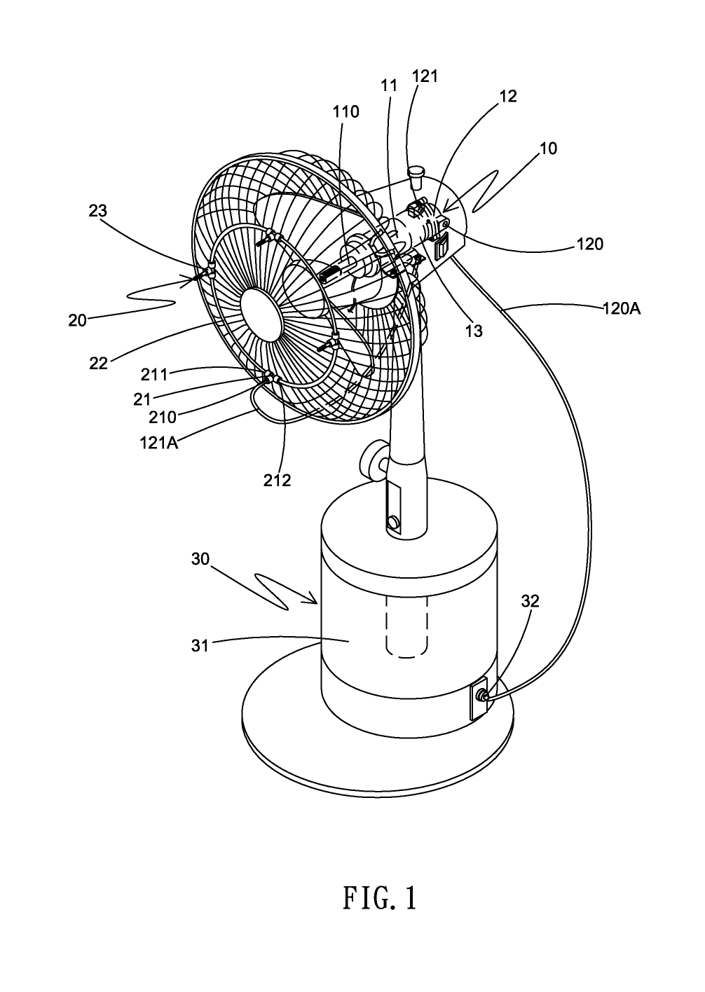

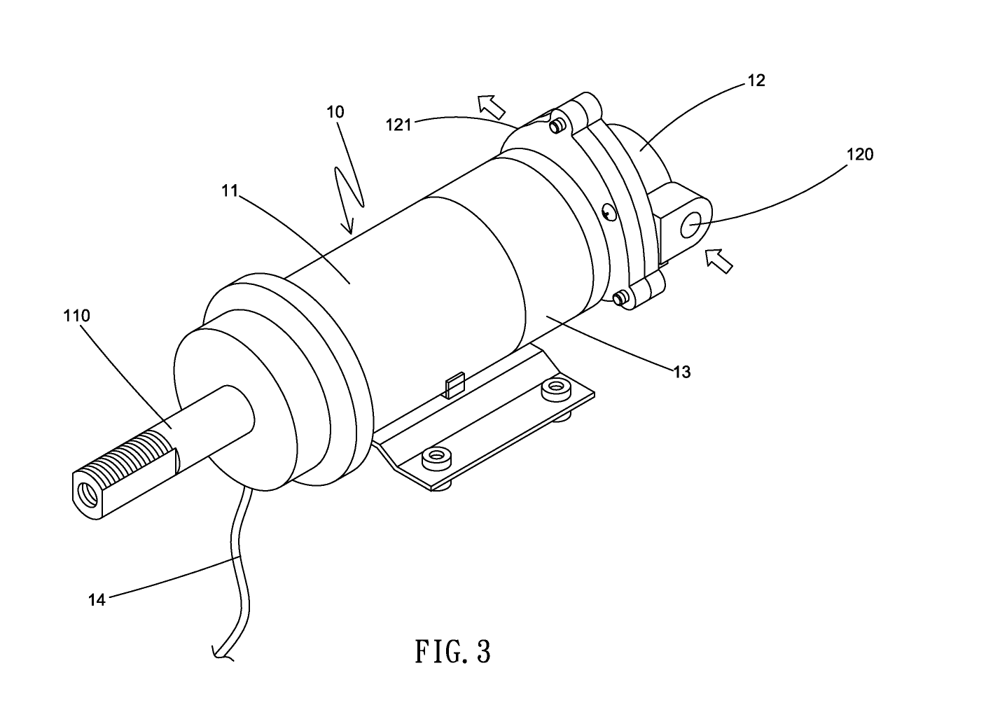

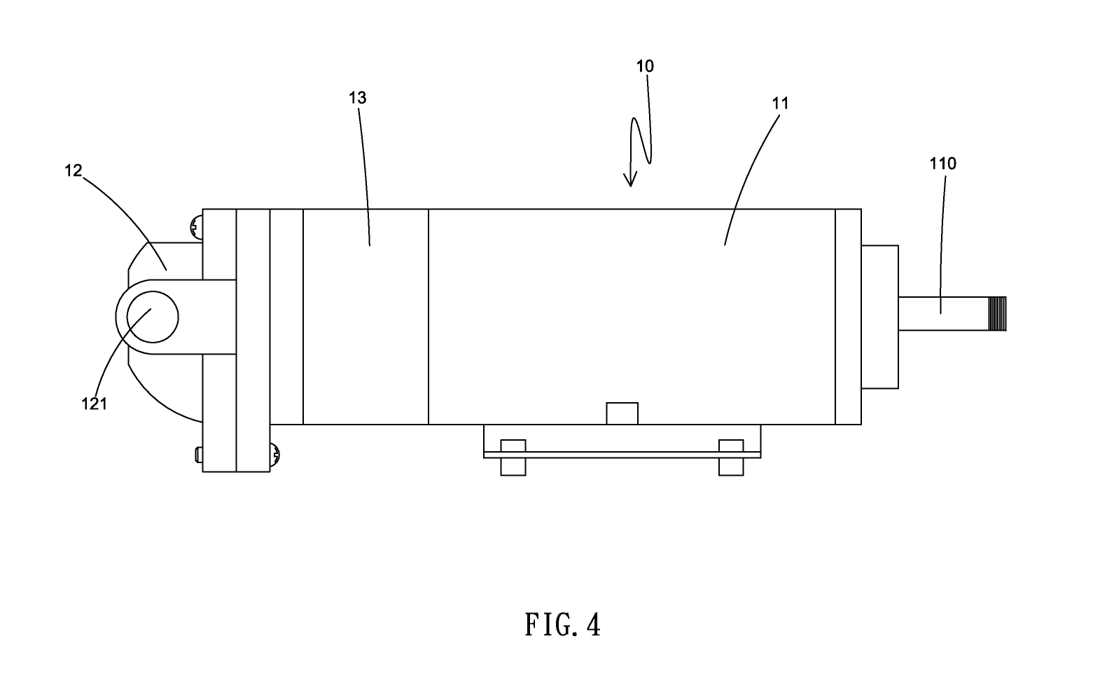

Referring to FIGS. 1 to 4, the fan of the present invention comprises a pump unit 10 which comprises a motor 11, a frame 12, a clutch 13 and a cable 14. The motor 11 has a shaft 110, and the frame 12 has an inlet 120 and an outlet 121. The inlet 120 is connected with an inlet tube 120A, and the outlet 121 is connected with an outlet tube 121A.

A nozzle unit 20 has a T-shaped one-way part 21 which has an input end 210, an output end 211 and a one-way end 212. An input tube 22 is connected between the input end 210 and the one-way end 212. Multiple nozzles 23 are connected to the input tube 22. The input end 210 of the T-shaped one-way part 21 is connected with the outlet tube 121A of the outlet 121 of the frame 12.

A reservoir 30 has a space 31 defined therein so as to receive water therein. A connector 32 is connected to the outside or the bottom of the reservoir 30. The inlet tube 120A of the inlet 120 of the frame 12 is connected to the connector 32.

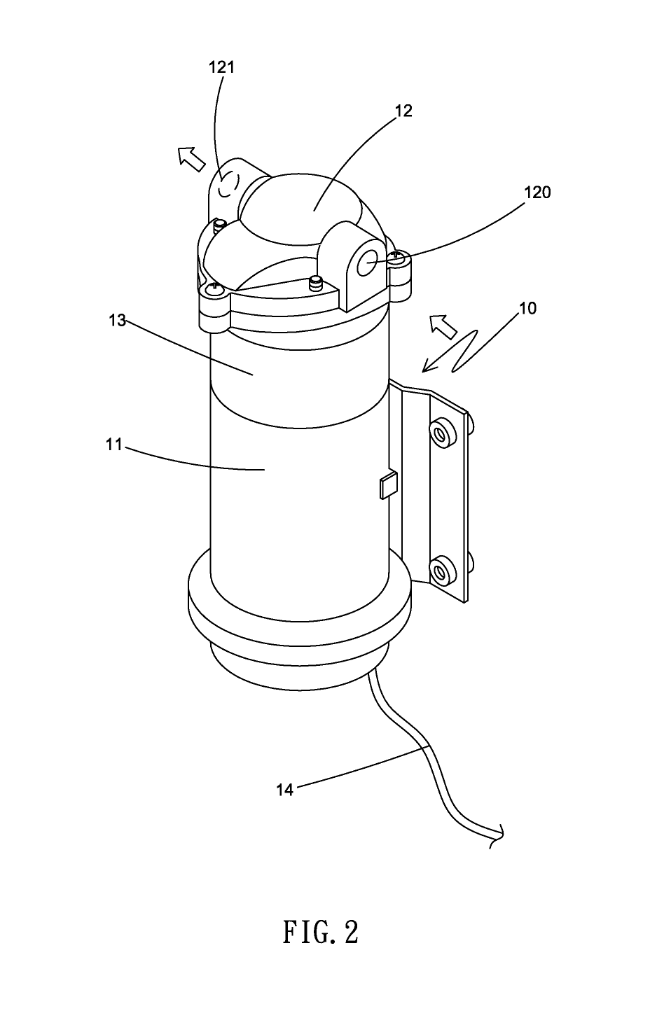

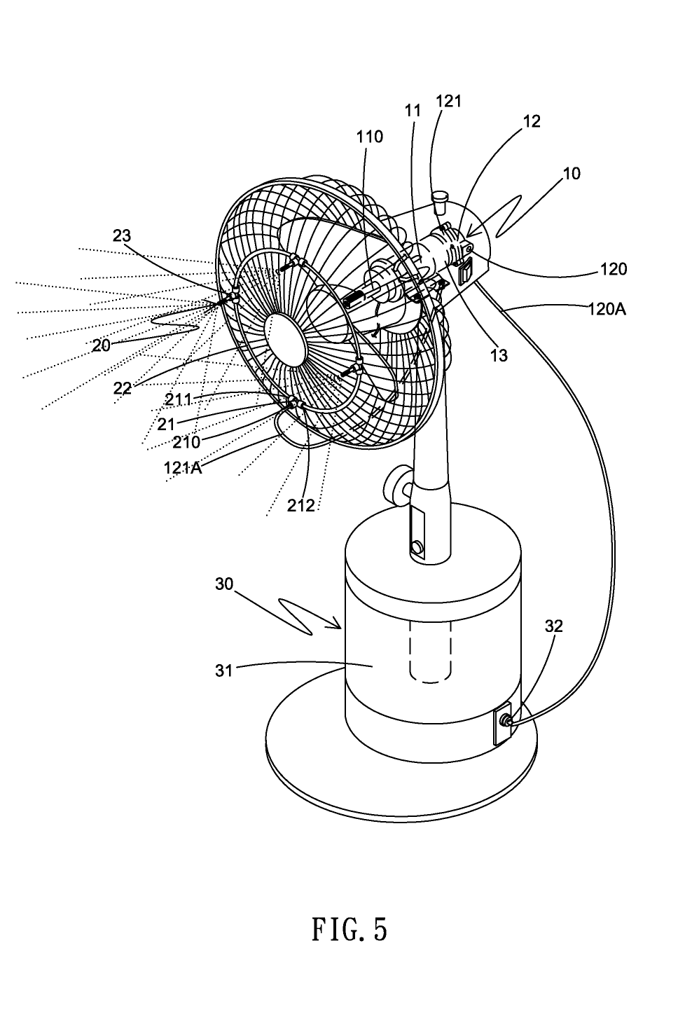

As shown in FIGS. 2 to 5, the input end 210 of the T-shaped one-way part 21 is connected with the outlet tube 121A on the outlet 121 of the frame 12. The connector 32 is connected the inlet tube 120A of the inlet 120 of the frame 12. The cable 14 introduces electric power to the motor 11 which drives the shaft 110 to rotate the fan blades so as to generate air flows. The clutch 13 is cooperated with the motor 11 so that the water is pumped by the pump unit 10 and sent to the nozzles 23 via the inlet tube 120A and the outlet tube 121A of the frame 12. The water is atomized and spread via the nozzles 23 by the air flows. The fan of the present invention uses one pump unit 10 to drive the fan and deliver the atomized water particles. The structure of the fan of the present invention is simple and the energy-consuming is low.

The fan of the present invention has the simple structure, wherein the cable 14 introduces electric power to the motor 11 which drives the shaft 110 to rotate the fan blades so as to generate air flows. The clutch 13 is cooperated with the motor 11 so that the water is pumped by the pump unit 10 and sent to the nozzles 23 via the inlet tube 120A and the outlet tube 121A of the frame 12. The water is atomized and spread via the nozzles 23 by the air flows. The fan of the present invention uses one pump unit 10 to drive the fan and deliver the atomized water particles.

There is only pump unit 10 required to pump the water and drive the fan so that the energy-consuming is low.

While we have shown and described the embodiment in accordance with the present invention, it should be clear to those skilled in the art that further embodiments may be made without departing from the scope of the present invention.

What is claimed is:

1. A fan comprising:
a pump unit having a motor, a frame, a clutch and a cable, the motor having a shaft, the frame having an inlet and an outlet, the inlet connected with an inlet tube, the outlet connected with an outlet tube;
a nozzle unit having a T-shaped one-way part which has an input end, an output end and a one-way end, an input tube connected between the input end and the one-way end, multiple nozzles connected to the input tube, the input end of the T-shaped one-way part connected with the outlet tube of the outlet of the frame, and
a reservoir having a space defined therein, a connector connected to the reservoir, the inlet tube of the inlet of the frame connected to the connector.

2. The fan as claimed in claim 1, wherein the connector connected to an outside of the reservoir.

3. The device as claimed in claim 1, wherein the connector connected to a bottom of the reservoir.
